(19) United States
(12) Patent Application Publication
(10) Pub. No.: US 2026/0249424 A1
(43) Pub. Date: Aug. 27, 2026

(54) ABRASIVE ARTICLES, SYSTEMS AND METHODS OF USE

(71) Applicant: 3M INNOVATIVE PROPERTIES COMPANY, St. Paul, MN (US)

(72) Inventors: Joseph B. Eckel, Vadnais Heights, MN (US); Thomas J. Nelson, Woodbury, MN (US); Gregory P. Sorenson, Maplewood, MN (US); Paul Larking, Staffordshire (GB); Theo L. Simon, Warwickshire (GB); David T. Buckley, Falcon Heights, MN (US); Dominic J. Triana, Minneapolis, MN (US)

(21) Appl. No.: 18/875,958

(22) PCT Filed: Jun. 16, 2023
(86) PCT No.: PCT/IB2023/056279

§ 371 Date: Dec. 17, 2024

Related U.S. Application Data
(60) Provisional application No. 63/366,803, filed on Jun. 22, 2022.

(51) Int. Cl. B24B 49/12; B24B 49/00; B24B 49/16

(52) U.S. Cl. CPC B24B 49/12; B24B 49/006; B24B 49/16

(57) ABSTRACT

An abrasive article evaluation system is presented that includes a camera that images an abrasive article. The system includes an efficiency indication generator that, based on the image, generates an indication of abrasive efficacy for the abrasive article. The system also includes a command generator that generates a command based in the generated abrasive efficacy indication.

### BACKGROUND

Coated abrasive articles containing shaped abrasive grains are useful for shaping, finishing, or grinding a wide variety of materials and surfaces such as wood, metals (e.g., especially non-ferrous metals such as aluminum that tend to clog grinding wheels), and flash. There continues to be a need for improving the cost, performance, and/or life of coated abrasive articles.

### SUMMARY

An abrasive article evaluation system is presented that includes a camera that images an abrasive article. The system includes an efficiency indication generator that, based on the image, generates an indication of abrasive efficacy for the abrasive article. The system also includes a command generator that generates a command based in the generated abrasive efficacy indication.

A robotic abrading system is presented that includes an abrasive article including abrasive particles within a bond matrix. The system also includes a robot arm configured to move one of the abrasive article and a substrate into position, such that the abrasive article contacts the substrate. The system also includes a force control unit on the robot arm. The force control unit applies a force to the abrasive article or the substrate. The system also includes an article evaluation system that images the abrasive article, evaluates the abrasive article, and, based on the evaluation, generates an updated operational parameter for the robotic abrading system.

Described herein are systems and methods for detecting when an abrasive article is nearing the end of its useful life. Some systems and methods herein may improve efficiency of use of abrasive articles as abrasive particles are worn down. However, systems and methods herein are not limited to measuring wear of abrasive particles. It may also be useful to detect wear of a resin matrix, for example in a nonwoven or bonded abrasive article where the entire article wears down during use. Some abrasive articles experience wear of particles and resin down to a backing layer, providing opportunities to visually detect changes.

Some systems and methods herein may be particularly useful for robotic abrading systems, where a human operator is not available to detect the end of life by noticing the change in abrading efficiency. Additionally, some systems and methods herein may be useful for handheld abrasive tools to assist an operator in adjusting use parameters for a tool during an abrading operation.

The above summary of the present disclosure is not intended to describe each disclosed embodiment or every implementation of the present disclosure. The description that follows more particularly exemplifies illustrative embodiments. It is to be understood, therefore, that the following description should not be read in a manner that would unduly limit the scope of this disclosure.

### BRIEF DESCRIPTION OF THE DRAWINGS

FIG. 1 is a top-down schematic of an exemplary coated abrasive article.

FIG. 2 is a schematic cross-sectional view of an exemplary coated abrasive article.

FIG. 3 illustrates a robotic abrading system that may benefit from embodiments herein.

FIG. 4 illustrates a hand held abrading system that may benefit from embodiments herein.

FIG. 5 illustrates an abrasive article evaluation system in accordance with embodiments herein.

FIG. 6 illustrates a method of evaluating abrasive article efficacy in accordance with embodiments herein.

FIGS. 7A-7B illustrate a metal capping quantification in accordance with embodiments herein.

FIG. 8 illustrates a method of evaluating metal capping in accordance with embodiments herein.

FIGS. 9A-9C illustrate a bearing area computation in accordance with embodiments herein.

FIGS. 10A-10B illustrate presentation of a bearing area computation to an operator in accordance with embodiments herein.

FIGS. 11A-11B illustrate the results of a computer vision algorithm applied to images of an abrasive article.

FIGS. 12A-12B illustrate a patterned abrasive article before and after use.

FIG. 13 is a defect inspection system architecture.

FIGS. 14-16 show examples of computing devices that can be used in embodiments shown in previous Figures.

FIGS. 17-20 illustrate examples of detecting and quantifying abrasive article efficacy.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “shaped abrasive particle,” means an abrasive particle with at least a portion of the abrasive particle having a predetermined shape that is replicated from a mold cavity used to form the shaped precursor abrasive particle. Except in the case of abrasive shards (e.g. as described in US Patent Application Publication Nos. 2009/0169816 and 2009/0165394), the shaped abrasive particle will generally have a predetermined geometric shape that substantially replicates the mold cavity that was used to form the shaped abrasive particle. Shaped abrasive particle as used herein excludes abrasive particles obtained by a mechanical crushing operation. Suitable examples for geometric shapes having at least one vertex include polygons (including equilateral, equiangular, star-shaped, regular and irregular polygons), lens-shapes, lune-shapes, circular shapes, semicircular shapes, oval shapes, circular sectors, circular segments, drop-shapes and hypocycloids (for example super elliptical shapes).

For the purposes of this invention, geometric shapes are also intended to include regular or irregular polygons or stars wherein one or more edges (parts of the perimeter of the face) can be arcuate (either of towards the inside or towards the outside, with the first alternative being preferred). Hence, for the purposes of this invention, triangular shapes also include three-sided polygons wherein one or more of the edges (parts of the perimeter of the face) can be arcuate. The second side may include (and preferably is) a second face. The second face may have a perimeter of a second geometric shape.

For the purposes of this invention, shaped abrasive particles also include abrasive particles comprising faces with different shapes, for example on different faces of the abrasive particle. Some embodiments include shaped abrasive particles with different shaped opposing sides. The different shapes may include, for example, differences in surface area of two opposing sides, or different polygonal shapes of two opposing sides.

The shaped abrasive particles are typically selected to have an edge length in a range of from 0.001 mm to 26 mm, more typically 0.1 mm to 10 mm, and more typically 0.5 mm to 5 mm, although other lengths may also be used.

The shaped abrasive particle may have a “sharp portion” which is used herein to describe either a sharp tip or a sharp edge of an abrasive article. The sharp portion may be defined using a radius of curvature, which is understood in this disclosure, for a sharp point, to be the radius of a circular arc which best approximates the curve at that point. For a sharp edge, the radius of curvature is understood to be the radius of the curvature of the profile of the edge on the plane perpendicular to the tangent direction of the edge. Further, the radius of curvature is the radius of a circle which best fits a normal section, or an average of sections measured, along the length of the sharp edge. The smaller a radius of curvature, the sharper the sharp portion of the abrasive particle. Shaped abrasive particles with sharp portions are defined in U.S. Provisional Patent Application Ser. No. 62/877,443, filed on Jul. 23, 2019, which is hereby incorporated by reference.

In the instance that the abrasive particles are precisely-shaped (e.g., into triangular platelets or conical particles), this effect of orientation can be especially important as discussed in U.S. Pat. Appl. Publ. No. 2013/0344786 A1 (Keipert), incorporated by reference herein. As used herein, the term “alignment” is used to refer to a relative position of an abrasive particle on a backing, while the term “orientation” refers to a rotational position of the abrasive particle at the aligned position. For example, a triangle-shaped particle may have a “tip up” orientation or a “tip down” orientation with respect to the backing.

As used herein, the term shaped abrasive particle refers to a monolithic abrasive particle. As shown, shaped abrasive particle is free of a binder and is not an agglomeration of abrasive particles held together by a binder or other adhesive material.

Described in embodiments here are abrasive articles that include wear indicators or other abrasive efficiency indicators. Some example embodiments are described in the context of particular abrasive article types, such as bonded abrasive wheels or a coated fiber disc. However, it is expressly contemplated that at least some efficiency indicators herein are applicable to multiple types of abrasive articles, and the figures and examples described herein are not intended to be limited.

Additionally, with respect to coated abrasive articles, many examples herein discuss abrasive discs specifically. However, it is expressly contemplated that abrasive belts may also benefit from efficacy indicators described herein.

Further, with respect to bonded abrasive articles, some examples of grinding wheels are described herein. However, it is expressly contemplated that wear indicators suitable for some grinding articles may be suitable for others. Bonded abrasive articles may use vitreous, resin or polymer-based bond matrices. Bonded abrasive structures may include depressed center grinding wheels, cut off wheels, cut-and-grind wheels, precision bonded wheels, cup wheels, segmented grinding wheels, etc.

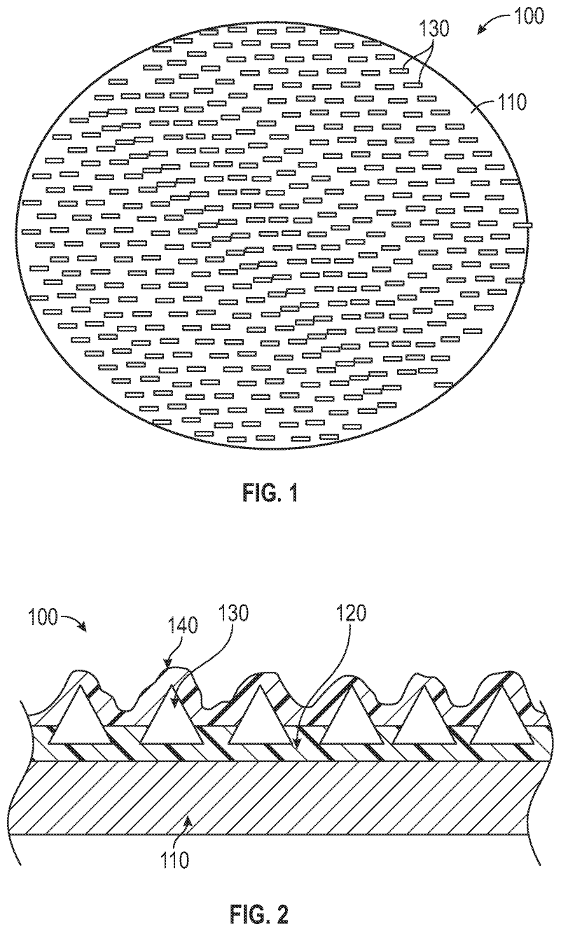

FIGS. 1 and 2 show an exemplary coated abrasive disc 100 according to the present disclosure, wherein shaped abrasive particles 130 are secured at precise locations and Z-axis rotational orientations to a backing 110. In one embodiment, shaped abrasive particles 130 are triangular prism shaped particles that appear rectangular when viewed from above.

Generally, a coated abrasive article 100 includes a plurality of abrasive particles embedded within a make coat that secures the particles to a backing. The backing may be formed from any known flexible coated abrasive backing, for example. Suitable materials for the backing include polymeric films, metal foils, woven fabrics, knitted fabrics, paper, nonwovens, foams, screens, laminates, combinations thereof, and treated versions thereof.

The abrasive particles 130 may be embedded within an abrasive layer, which can include multilayer construction having make 120 and size layers 140. Coated abrasive articles according to the present disclosure may include additional layers such as, for example, an optional supersize layer that is superimposed on the abrasive layer, or a backing antistatic treatment layer may also be included, if desired. Exemplary suitable binders can be prepared from thermally curable resins, radiation-curable resins, and combinations thereof.

Make layer 120 can be formed by coating a curable make layer precursor onto a major surface of backing 110. The make layer precursor may include, for example, glue, phenolic resin, aminoplast resin, urea-formaldehyde resin, melamine-formaldehyde resin, urethane resin, free-radically polymerizable polyfunctional (meth)acrylate (e.g., aminoplast resin having pendant α,β-unsaturated groups, acrylated urethane, acrylated epoxy, acrylated-isocyanurate), epoxy resin (including bis-maleimide and fluorene-modified epoxy resins), isocyanurate resin, and mixtures thereof. Of these, phenolic resins are preferred.

Phenolic resins are generally formed by condensation of phenol and formaldehyde, and are usually categorized as resole or novolac phenolic resins. Novolac phenolic resins are acid-catalyzed and have a molar ratio of formaldehyde to phenol of less than 1:1. Resole (also resol) phenolic resins can be catalyzed by alkaline catalysts, and the molar ratio of formaldehyde to phenol is greater than or equal to one, typically between 1.0 and 3.0, thus presenting pendant methylol groups. Alkaline catalysts suitable for catalyzing the reaction between aldehyde and phenolic components of resole phenolic resins include sodium hydroxide, barium hydroxide, potassium hydroxide, calcium hydroxide, organic amines, and sodium carbonate, all as solutions of the catalyst dissolved in water.

Resole phenolic resins are typically coated as a solution with water and/or organic solvent (e.g., alcohol). Typically, the solution includes about 70 percent to about 85 percent solids by weight, although other concentrations may be used. If the solids content is very low, then more energy is required to remove the water and/or solvent. If the solids content is very high, then the viscosity of the resulting phenolic resin is too high which typically leads to processing problems.

Phenolic resins are well-known and readily available from commercial sources. Examples of commercially available resole phenolic resins useful in practice of the present disclosure include those marketed by Durez Corporation under the trade designation VARCUM (e.g., 29217, 29306, 29318, 29338, 29353); those marketed by Ashland Chemical Co. of Bartow, Florida under the trade designation AEROFENE (e.g., AEROFENE 295); and those marketed by Kangnam Chemical Company Ltd. of Seoul, South Korea under the trade designation PHENOLITE (e.g., PHENOLITE TD-2207).

The make layer precursor may be applied by any known coating method for applying a make layer to a backing such as, for example, including roll coating, extrusion die coating, curtain coating, knife coating, gravure coating, and spray coating.

The basis weight of the make layer utilized may depend, for example, on the intended use(s), type(s) of abrasive particles, and nature of the coated abrasive article being prepared, but typically will be in the range of from 1, 2, 5, 10, or 15 grams per square meter (gsm) to 20, 25, 100, 200, 300, 400, or even 600 gsm. The make layer may be applied by any known coating method for applying a make layer (e.g., a make coat) to a backing, including, for example, roll coating, extrusion die coating, curtain coating, knife coating, gravure coating, and spray coating.

Once the make layer precursor is coated on the backing, the triangular abrasive particles are applied to and embedded in the make layer precursor. The triangular abrasive particles are applied nominally according to a predetermined pattern and Z-axis rotational orientation onto the make layer precursor. Using known orientation methods, such as electrostatic or magnetic orientation, it is possible to orient the abrasive particles with respect to the backing in order to improve performance of the particles.

However, while FIGS. 1-2 illustrate a coated abrasive article, it is expressly contemplated that systems and methods herein may also be suitable for understanding use and wear of other abrasive articles such as bonded abrasive articles with resin or vitreous bond matrices, nonwoven abrasive articles, brushes, or other abrasive articles.

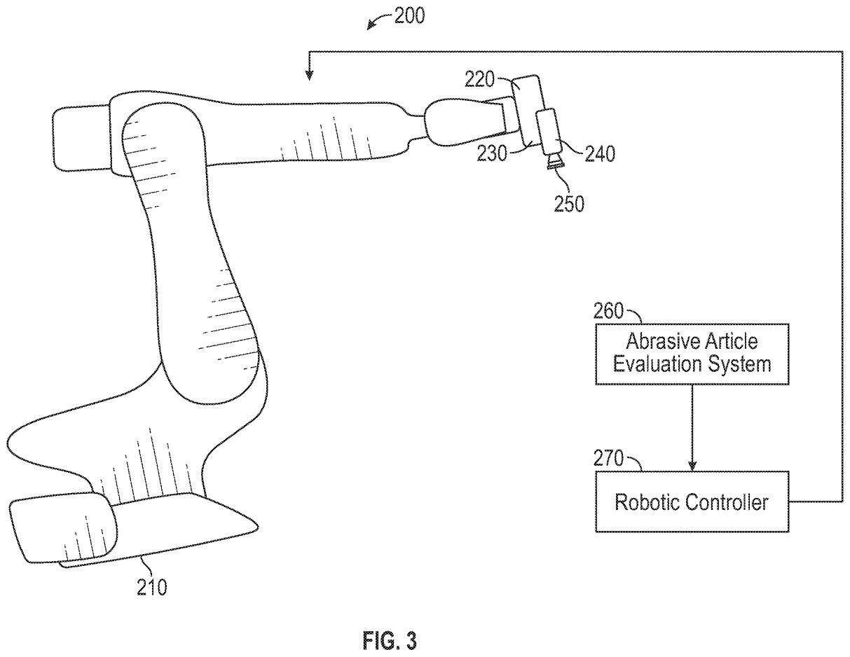

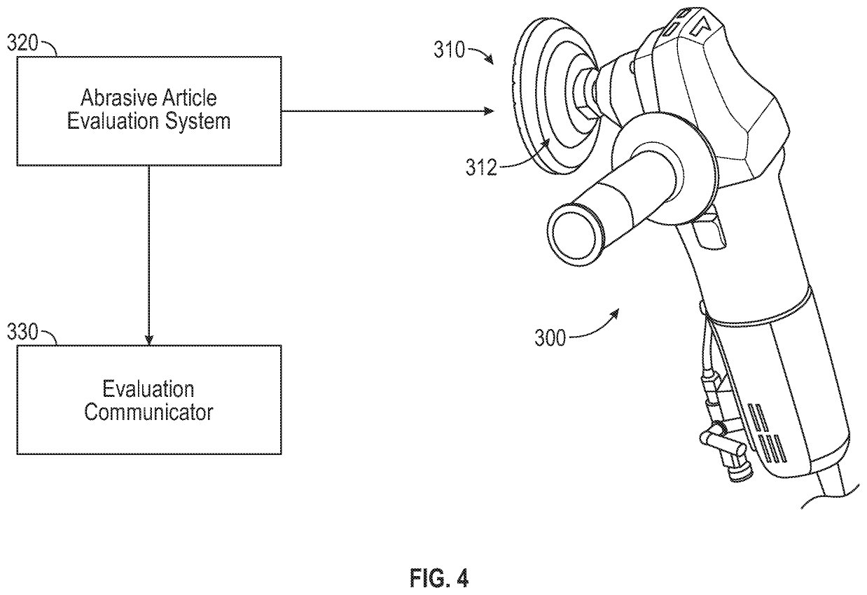

Abrasive articles may be used in a number of contexts. Described herein are the robotic repair context (FIG. 3) and the handheld tool context (FIG. 4). Different use scenarios of abrasive articles present different problems regarding article use over time. For example, an experienced human operator can often “feel” when an abrasive article is losing cut efficacy over time and adjust accordingly, by applying more force or adjusting an angle. Systems and methods herein can allow for a human operator to have an idea of how close an abrasive article is to the end of its useful service life.

A robotic system may have no insight into the wear or loading occurring on an abrasive article and may not make necessary adjustments, or replace an abrasive article when needed without intervention. For example, using known abrasive wear rates, process parameters can be modified to maintain abrasive efficacy throughout the service life of the abrasive article. Systems and methods herein may be useful in other contexts as well.

FIG. 3 is a schematic of a robotic arm that may benefit from embodiments disclosed herein. A robotic repair unit 200 has a base 210, which may be stationary, in some embodiments. In other embodiments, base 210 can move in any of six dimensions, translations or rotations about an x-axis, y-axis and/or z-axis. For example, robot 200 may have a base 210 fixed to a rail system configured to travel along with a moving substrate being repaired. Depending on a particular operation, robot 200 may need to move closer, or further away from a substrate, or may need to move higher or lower with respect to an abrading area. A moveable base 200 may thus increase functionality.

Robotic arm unit 200 has one or more tools 240 that can interact with a worksurface. Tool 240 may include a backup pad 250, in one embodiment, or another suitable abrasive tool. During an abrasive operation, tool 240 may have an abrasive disc, or other suitable abrasive article, attached using adhesive, hook and loop, clip system, vacuum or other suitable attachment system. However, as the abrasive article moves in conjunction with a backup pad 250 to which it is attached, the abrasive article is not necessarily considered as adding additional degrees of freedom to the movement of robotic repair unit 200. As mounted to the robotic repair unit 200, tool 240 has the ability to be positioned within the provided degrees of freedom by the robotic repair unit 200 (6 degrees of freedom in most cases) and any other degrees of freedom (e.g., a compliant force control 230 unit).

Backup pad 250 is coupled to a tool 240 which has an orbit that provides some additional degrees of freedom. In most tools a single degree of freedom is provided by a rotating shaft with or without some offset. Tool 240 is coupled to a force control 230 unit output. Force controlled flange 230 provides a soft (i.e., not stiff) displacement curve. In most force control units, a single degree of freedom is provided by a sliding (prismatic) joint along the active axis. Force control 230 is coupled to a flange 220. Movement of components 210, 220, 230, 240 and 250 is all controllable using a robot controller (e.g., robot controller 270).

Robotic controller 270, in addition to moving components 210-250 based on the parameters of an abrading operation, may also adjust parameters based on information received from an abrasive article use evaluation 260. For example, if evaluation system 260 indicates that an abrasive article has reached an end of life, controller 270 may instruct system 200 to stop an abrading operation, change out the old abrasive article for a new abrasive article, and then continue an abrading operation. Additionally, for example, controller 270 may provide new parameters for abrading based on the feedback from system 260. For example, if an abrasive article loaded, controller 270 may increase a coolant flow to flush accumulated swarf. If the abrasive article is capped, controller 270 may initiate a dressing process to alleviate detected metal capping. If the abrasive article is worn, but not at end of life, controller may increase a force applied by force control unit 230, or may adjust an angle of tool 240 with respect to a substrate. Such adjustments are described in greater detail with reference to later figures.

FIG. 4 illustrates a hand tool 300 that may be used by a human operator during an abrading operation. Tool 300 includes an abrasive article 310 coupled to a backup pad 312. Tool is maneuverable by a human operator such that an angle of the abrasive article 310 is adjustable. An applied force may also be adjustable, for example by a human operator leaning into an operation.

While experienced human operators may be able to adjust operational conditions based on a “feel” of the abrading operation, at least some operators may benefit from an evaluation system 320. Abrasive article evaluation system 320 may detect use conditions of abrasive article 310 and evaluation communicator 330 may communicate a wear condition or operating condition of the abrasive article to the human operator. For example, tool 300 may include a display that provides instructions for a human operator—e.g. based on an internal gyroscope or accelerometer the tool may guide the user into adjusting an angle of the tool with respect to a surface. In other embodiments, communicator 330 may display results, instructions or suggestions on a display associated with the human operator—such as a display on protective gear worn by the user (e.g. a heads up display or an augmented reality overlay provided on safety glasses) or on a display in the area. Communicator 330 may also communicate results in another manner, such as audibly, or just by indicating that the abrasive article is acceptable for continued use or unacceptable for continued use.

Described herein are systems and methods for evaluating an abrasive article. The abrasive article may be associated with a robotic abrading system, like that illustrated in FIG. 3, or may be a human operated tool, like that illustrated in FIG. 4. Evaluating the abrasive article is broadly used to refer to evaluating a parameter related to abrasive efficiency of the abrasive article. Abrasive efficacy may be affected by wear—as the article is used and the particles ground down, the cut rate decreases. However, abrasive efficacy can also be affected by other factors that may be detectable using systems and methods herein. For example, metal capping or loading may occur, causing abrasive particle tips to be covered and unavailable for abrading. Other efficacy factors may also be detectable.

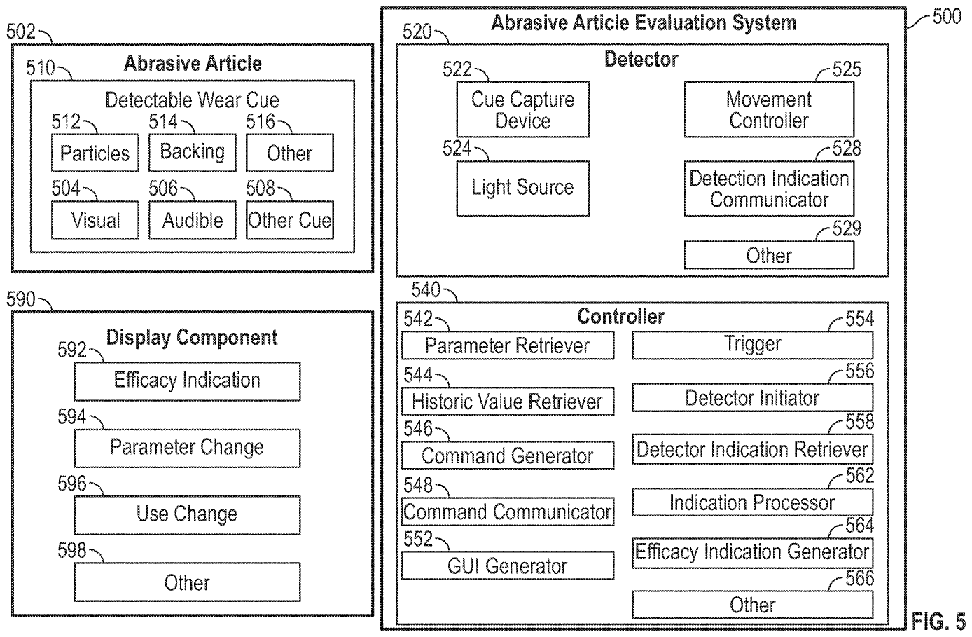

FIG. 5 illustrates an abrasive article evaluation system in accordance with embodiments herein. Abrasive article evaluation system 500 is suitably accessible for an abrasive article 502. For example, a robotic arm may move an abrasive article 502 in range of detector 502 with a cue capture device 522. In some embodiments herein, cue capture device 522 is a camera or other image capturing component that images the abrasive article 502. In other embodiments, cue capture device 522 is a sensor that captures another signal, such as a sound, a vibration, a weight, a thickness or another parameter of abrasive article 502 as described in embodiments herein. In embodiments where cue capture device 522 is a camera, detector 520 may also have a light source 524. The light source may provide illumination in the visual spectrum, ultraviolet spectrum, infrared spectrum or another wavelength suitable for detecting cue 510.

As described herein, an abrasive article 502 includes a cue 510 that can be detectable by a sensor 522. The cue may be incorporated into particles 512 within abrasive article 502, a backing 514 or resin structure, or another component 516 of the abrasive article. The detectable cue 510 may be a visual indication 504, an audible indication 506, or another cue 508. For example, cue 510 could be a detectable weight loss or shrinkage of an abrasive article 502 that is detectable by a scale or calipers.

Detector 520 may be stationary, such that a robotic arm or a human operator brings abrasive article 502 into range of cue capture device 522. In other embodiments, detector 520 is mobile, with a movement controller 525 that can move cue capture device 522, light source 524 or other component 529 into position to detect cue 510. Detector 520 may communicate a signal generated by cue capture device 522 using a detection indication communicator 528. However, it is expressly contemplated that, while detector 520 is illustrated in FIG. 5 as separate from a controller 540 that completes an evaluation, they may be a single component in some embodiments.

Controller 540 receives a detection indication from detector 520 using a detector indicator retriever 558. Detection indicator retriever 558 may request an indication from detector 520, in response to a detector initiator 556, which may send a command to detector 520 to actuate cue capture device 522. A trigger 554 may cause detector initiator 556 to actuate, in some embodiments. For example, a motion detector 554 may detect that abrasive article 502 has moved into position. Trigger 554 may also be time or position based.

Indication processor 562 processes the received signal from detector 520. As described herein, that may include comparing the received signal to a threshold, reviewing it against a historic signal value retrieved from a datastore by historic value retriever 544, or otherwise processing the signal to determine whether an abrasive efficacy of article 502 has reached an undesired low. As described in greater detail herein, indication processor 562 may also conduct processing steps such as applying machine learning to a detected cue. For example, indication processor 562 may process a captured image of abrasive article 502 to evaluate an amount of metal capping that has accumulated on an abrasive article surface or an amount of bearing area available for the next abrasive operation, or to apply pattern recognition techniques to determine wear of a patterned abrasive. Metal capping occurs when metal adheres to an abrasive grain, for example due to excessive heat and/or insufficient pressure. Metal capping prevents an abrasive particle from fracturing, which allows the abrasive particle to resharpen itself.

Indication processor 562 may evaluate against a threshold that is set by a manufacturer, a customer, an operator, a shift supervisor, etc. For example, one customer may set a lowest acceptable efficacy of an abrasive disc as E while a second sets the threshold at ET.

In some embodiments, controller 540 may determine that, while an abrasive efficacy has dropped below a threshold, it may be possible to improve by altering one or more operational parameters. Parameter retriever 542 may retrieve a current set of operating parameters—such as an applied force from a force control unit, an abrading angle from an accelerometer, etc. A command generator 546 may generate a command, for example to a robot arm controller to adjust an applied force or angle, which is then communicated to the robot arm controller, using command communicator 548. Command generator 546 may also generate a command to exchange abrasive article 502 for a new abrasive article, or to re-dress abrasive article 502 to remove loading or metal capping. In some embodiments, command generator 546 and command communicator 548 may operate automatically, such that a robot controller is continuously adjusting parameters to improve abrading efficacy.

An efficacy indication generator 564 generates an indication of an abrading efficacy of abrasive article 502. The indication may be displayed, for example on a display component 590. The indication may be provided in words, e.g. “60% used” or “metal capping detected” or may be provided as a simple “good” or “bad.” The indication may be audible, e.g. an alarm or signal indicating that action is needed to improve the abrading efficacy or to replace abrasive article 502. The indication may be provided to a graphical user interface generator 552, which may generate an interface for display component 590. Controller 540 may also have other functionality 566.

Display component 590 may be incorporated into a hand tool, in some embodiments, such that an efficacy indication 592 is visible to a user of the hand tool. In other embodiments, display component 590 is separate from a tool. For example, in a robotic abrading context, display component 590 may be separate from a robotic arm, but visible to an operator. In some embodiments, display component 590 is part of a mobile computing device, such as an operator's mobile phone or tablet. GUI generator 552 may then send an indication to an application running on the device, such that efficacy indication 592 can be updated.

Display component 590 may also present a parameter change 594, such as an adjustment of a tool angle, an increase or decrease in applied force, etc. A use change 596 may also be indicated. For example, a coated abrasive article that has experienced significant wear may no longer be appropriate for an initial high-volume abrading removal step of a process, but may be suitable for a later, lower-volume abrading removal step. Display component 590 may also provide other information 598, received from controller 540, detector 520 or elsewhere. For example, a unit count of parts completed, an average abrading time, or other relevant information may be displayed.

System 500 is illustrated as separate from display component 590 in FIG. 5, however it is expressly contemplated that a single computing unit may include display component 590 and some or all of the components of system 500. For example, detector 520 and controller 540 are illustrated as part of a single unit, it is expressly contemplated that at least some components may be part of separate devices. For example, controller 540 may be part of a robotic arm controller, a separate computing device remote from detector 520 and display component 590.

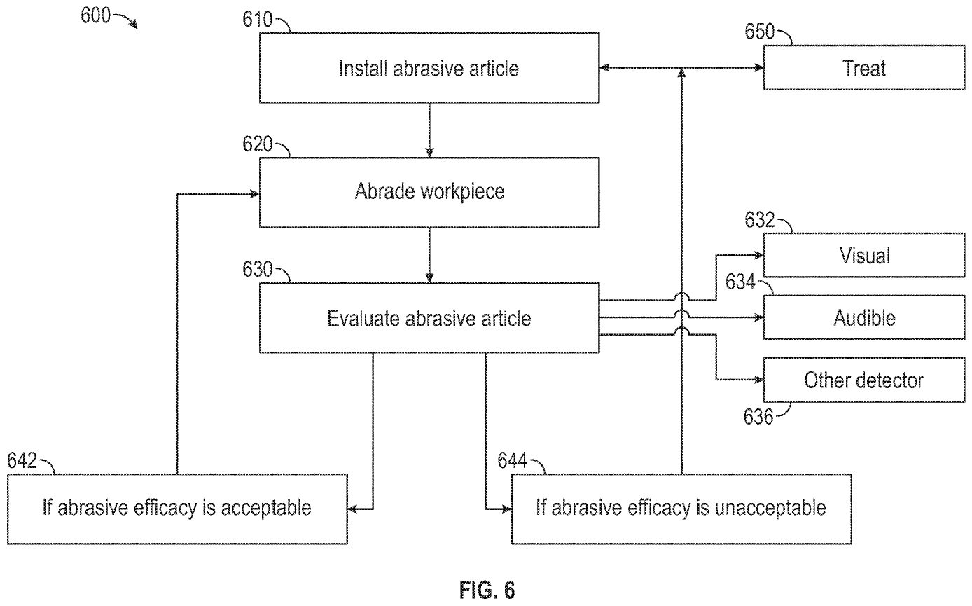

FIG. 6 illustrates a method of evaluating an abrasive article. In some embodiments, evaluating may be automatically completed using method 600. For example, a robotic arm or a human operator may move an abrasive article within range of, or past, a detector which may capture a signal indicative of abrading efficacy of the abrasive article.

In block 610, an abrasive article is installed on a tool. For example, the abrasive article may be coupled to a backup pad on a handheld abrasive tool or to a tool of a robotic abrading unit. The abrasive article may be any suitable abrasive article for a given abrading operation, such as a coated abrasive article, a bonded abrasive article, a bristle brush, or another suitable abrasive article.

In block 620, the abrasive article engages a workpiece and an abrading operation is conducted. As the workpiece is abraded, abrasive particles of the abrasive article experience wear. They may also experience metal capping, loading or other degradation.

In block 630, the abrasive article is evaluated. An abrading efficacy of the abrasive article is determined. A visual cue 632 may be analyzed to detect wear, metal capping or loading, in some embodiments. An audible cue 634 may be analyzed to detect wear, metal capping or loading. In other embodiments, a different detector 636 detects a cue of abrasive efficacy.

Evaluating the abrasive article may be done by directly measuring a parameter of the abrasive article, such as visual indicia, sounds, or other indicia of the abrasive article during or after an abrasive operation. In other embodiments, evaluating the abrasive article may be done by evaluating the workpiece, swarf removed from the workpiece, or another component. Evaluating may also include processing an image captured of the abrasive article surface to determine loading, metal capping, available bearing area, wear, or another parameter that affects abrasive efficacy.

Evaluation, in block 630, may be done automatically as part of an abrading process. For example, a robotic arm coupled to the abrasive article may change positions, for example while a completed workpiece is replaced by a new workpiece, such that the abrasive article is within range of a detector. Similarly, a human operator may set down an abrasive tool coupled to the abrasive article in a position within range of a detector while the human operator changes out a part to be abraded or completes another task.

In block 642, if the abrasive efficacy of the abrasive article is still at an acceptable level, then it can continue to be used for another abrasive operation. In some embodiments, new operational parameters are provided based on a detected decrease in abrasive efficacy between evaluations. In a robotic abrading operation, the new parameters may be automatically implemented. In a handheld tool context, the new parameters may be suggested to an operator.

In block 644, if the abrasive efficacy is below an acceptable level, it can either be treated, as indicated in block 650, for example by dressing the abrasive article to remove metal capping, washing or cleaning the abrasive article to remove loading. However, in some embodiments, method 600 returns to block 610.

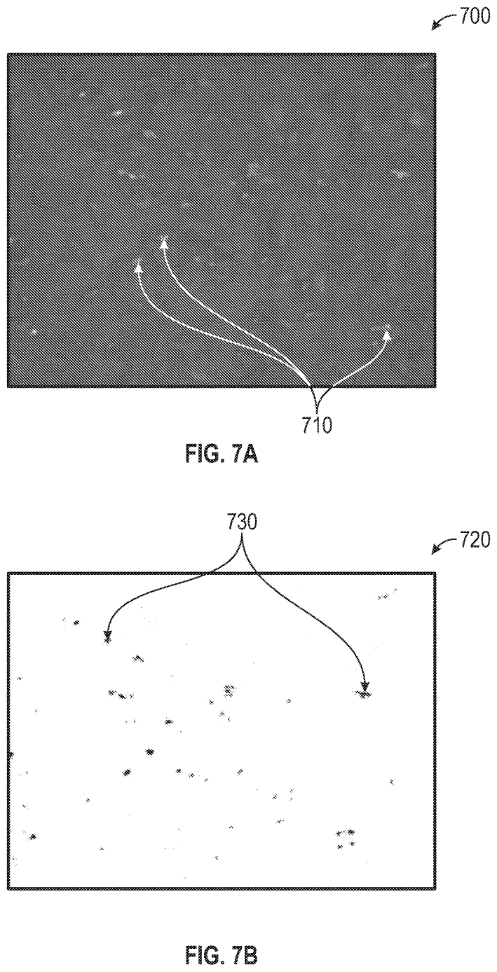

Described herein in FIGS. 7-12 are examples and embodiments of the present invention where a detected indication of abrasive efficacy are visual in nature. However, it is expressly contemplated, and described in co-pending applications 63/366,805 and 63/366,802, both filed on Jun. 22, 2022, that other abrasive efficacy cues are possible.

FIGS. 7A-7B illustrate a metal capping quantification in accordance with embodiments herein. FIG. 7A illustrates an image 700 captured of an abrasive article surface in which abrasive particles can be seen with tips exposed through a resin layer. Metal capping 710 can be seen on some of the tips. Metal capping is a common phenomena that results from metal depositing on abrasive grains, such as in stainless steel abrading operations. Metal capping reduces the abrasive efficacy because the sharp tips of abrasive particles are covered. Metal capping can be removed or reduced by re-dressing the abrasive article to remove the metal capping. Additionally, metal capping can be reduced in future operations by adjusting parameters, for example so that a robotic abrading system increases applied force to encourage fracturing of abrasive particles.

FIG. 7B illustrates a processed image 720, obtained from image 700. Metal capping 730 causes reflectance. Regions in a photograph of an abrasive article showing high reflectivity is a good indicator of metal capping areas. Metal capping is illustrated more clearly when the image is converted to binary. Once converted to binary, capped particles 730 show up as black against a white background. A percentage of metal-capped abrasive articles can then be calculated by comparing the amount of black in the image to the total area of the image. The amount of metal capping may increase over time and, when the abrasive article reaches a degradation threshold, an alert can be generated to: replace the abrasive article, redress the abrasive article, or adjust an operational parameter to increase abrasive efficacy of the abrasive article.

The initial image 700 can be captured using any suitable camera. In some embodiments, an additional light source is provided to increase the reflectance of the capped particles. In some embodiments the image is underexposed. In some embodiments, the exposure and contrast is adjusted to make binary conversion accurate and avoid erroneous data points.

In embodiments where the abrading operation is a robotic abrading operation, the camera is mounted on a robotic arm, such that the abrasive article can be imaged in between abrading operations. However, it is expressly contemplated that the camera may also be positioned elsewhere, such as on a separate robotic system, on a mobile detection system, or a stationary detector. For example, a stationary camera can image a rotating belt and compare it to a static image, allowing for a correlation and enabling dynamic characterization of the belt.

Metal capping detection is also helpful for handheld abrasive operations. An operator may take an image of the abrasive article between abrasive operations, for example using a mobile computing device (e.g. smartphone, tablet, etc.) or by passing the abrasive article in front of a camera located near the abrading operation area. Other suitable image capture systems and techniques are also envisioned.

Abrasive articles may also be modified to improve metal capping detection. For example, a black or other dark colored size or supersize resin would increase contrast between capped particles and uncapped abrasive article. Currently, many manufacturers use coloring in resin layers to easily differentiate brand and, in some cases, grade of abrasive particles in an abrasive article. Additionally, additives may be included in the abrasive article to increase reflectance. For example, glass spheres, or other reflective material, may be included in the make or size coats of a coated abrasive article such that, as the abrasive article is ground down, the reflective material is exposed and reflectance increases. The reflected material may be provided as backfill, in some embodiments, or embedded into a backing, as suitable.

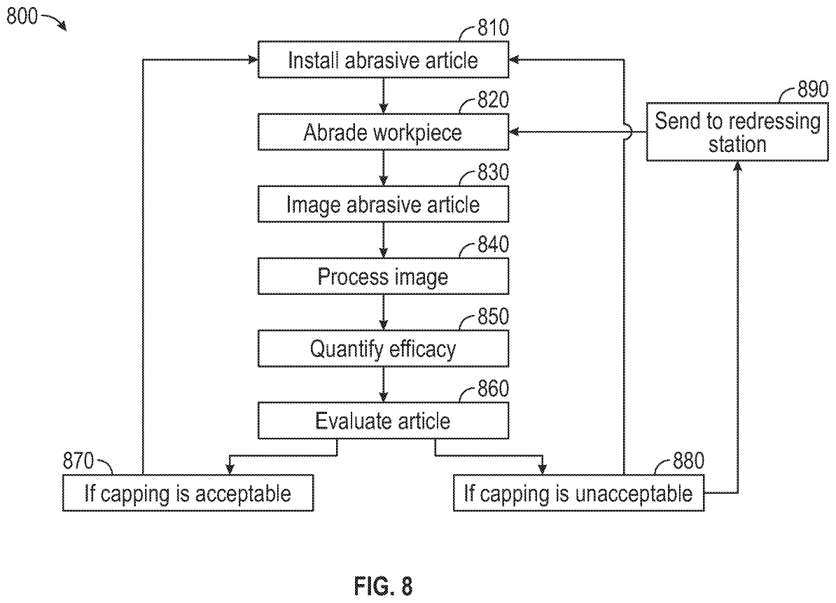

FIG. 8 illustrates a method of evaluating metal capping in accordance with embodiments herein. As noted above, metal capping reduces abrading efficacy. However, metal capping can be removed by redressing the abrasive article. Therefore, it is important to identify when metal capping has occurred so that it can be removed and the abrasive article used through its full potential service life. Method 800 may be implemented to automatically evaluate an abrasive article, for example in between abrasive operations. Particularly for the robotic abrasive industry, it would be particularly useful if method 800 can be done without adding to a total cycle time of an abrasive operation. However, method 800 is also useful for the handheld tool industry, provided that the evaluation can be done without interrupting an operator's process.

In block 810, an abrasive article is installed on a tool. The tool may be a handheld tool, with the abrasive article installed by an operator. However, it may also be an abrasive article installed on a robotic abrading machine. The abrasive article may be automatically installed, for example in response to an indication that the abrasive article has reached its end of life or needs to be redressed at a different station.

In block 820, the abrasive article is used to abrade a workpiece. The abrasive article contacts with substrate with an applied force, at a rotational speed, and for a dwell time selected for the abrasive operation. In the robotic context, the applied force, speed and dwell time may be selected or adjusted, for example, based on a known amount of wear or metal capping of the abrasive article, as described herein.

In block 830, the abrasive article is imaged. The imaging step may be done, for example, in between abrading operations while a tool is being moved from a first substrate abrading location to a second abrading location.

In block 840, the image is processed to quantify the reflectance. While converting to binary is described herein as one method of processing, it is expressly contemplated that any suitable processing that increases contrast and makes it possible to quantify reflectance is appropriate.

Described herein is a method that converts an image to binary. However, it is also contemplated that other methods may be possible, such as image processing using RBG filters to remove pixels above an RBG value threshold. For example, in an abrasive article with blue abrasive particles and a red size resin, any part of an image coming back as pure white is likely indicative of metal capping. Metal capping can then be estimated as the percentage of white area over total area.

In block 850, abrasive efficacy is quantified. Abrasive efficacy can be affected by general wear as well as metal capping or loading. In the binary example provided above, quantifying metal capping includes estimating the area showing “black” vs. the total area expected to contain abrasive particle tips. For determining end of life, or a need to redress the article, it may be sufficient to compare the amount of “black” (capped) area to the total area.

In block 860, the abrasive article is evaluated. This may include evaluating a quantified metal capping against a threshold to determine whether or not redressing is appropriate or would improve abrading efficacy. Evaluating may also include evaluating wear of the abrasive disc more generally to determine whether the disc is worn past a threshold where redressing will increase efficacy enough to be worthwhile.

In block 870, if metal capping is sufficiently low, the abrasive article can be used for the next abrasive operation. Evaluating, in block 860, may also include estimating wear or metal capping such that a new set of operational parameters can be provided to improve efficacy for the abrasive article. For example, the abrasive article may not have enough metal capping to justify being sent to a redressing station, as illustrated in block 890, but it may have enough wear that abrasive efficacy would improve with a higher force, faster speed or different angle. In some embodiments, metal capping and wear can be evaluated, in block 860, in the same step. It may be possible to evaluate wear using the same images captured to evaluate metal capping, as described herein, or by using another method as described in U.S. Patent Applications 63/366,805 or 63/366,802, filed herewith.

In block 880, if the metal capping has reached a redressing threshold, it is sent to a redressing station for a redressing operation. Redressing may include grinding the abrasive article against a redressing substrate to remove the metal capping. However, as illustrated by the arrows in FIG. 8, it may also be necessary to replace the abrasive article with a new abrasive article. For example, if redressing will cause the abrading efficacy to fall below a suitable threshold due to wear, the abrasive article should be replaced.

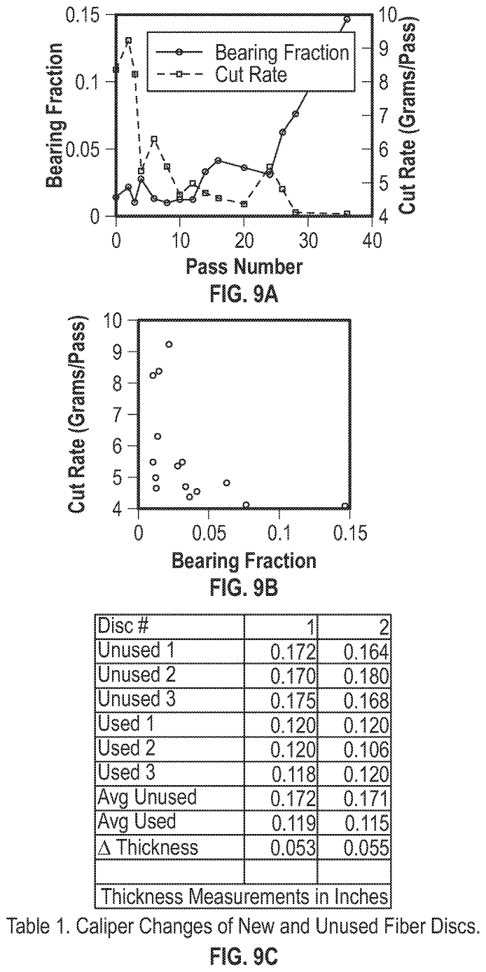

FIGS. 9A-9C illustrate a bearing area calculation. FIG. 9A illustrates bearing area and cut rate for an abrasive article over the lifetime of an abrasive disc, measured in abrasive passes on a substrate. FIG. 9B illustrates a chart of projected bearing area against cut rate per pass. FIG. 9C illustrates a table showing how disc thicknesses changed as a disc was used. The change in thickness is significant, but not readily measurable by the human eye. An ultrasonic caliper was used to obtain the measurements of FIG. 9C. Depending on the application, a different end thickness may determine when the abrasive article has reached the end of its life.

However, it may also be possible to measure the bearing area, or contacting projected area parallel to the surface being abraded, by analyzing a measurement of the surface height of the abrasive disc over a specified area. The image may be obtained using a structured light microscope, where the structured light helps to reduce shadows in the image. However, it may be possible to determine bearing area using 3D profilometry, for example using a structured light microscope.

First, a 3D profilometry scan of a portion of the abrasive disk surface is captured, for example using a structured light microscope. Then, the bearing area at a specific depth of cut (FIG. 9 used 20 microns) is calculated by integrating the xy area on the scan occupied by z-heights greater than 20 microns lower than the tallest z-height. The tallest z-height is determined by taking the median of the top 5 median heights in order to minimize the effect of outliers. In order to determine bearing area over the lifetime of the disk, this process is repeated on the same portion of the abrasive disk after several passes of the abrasive on a substrate.

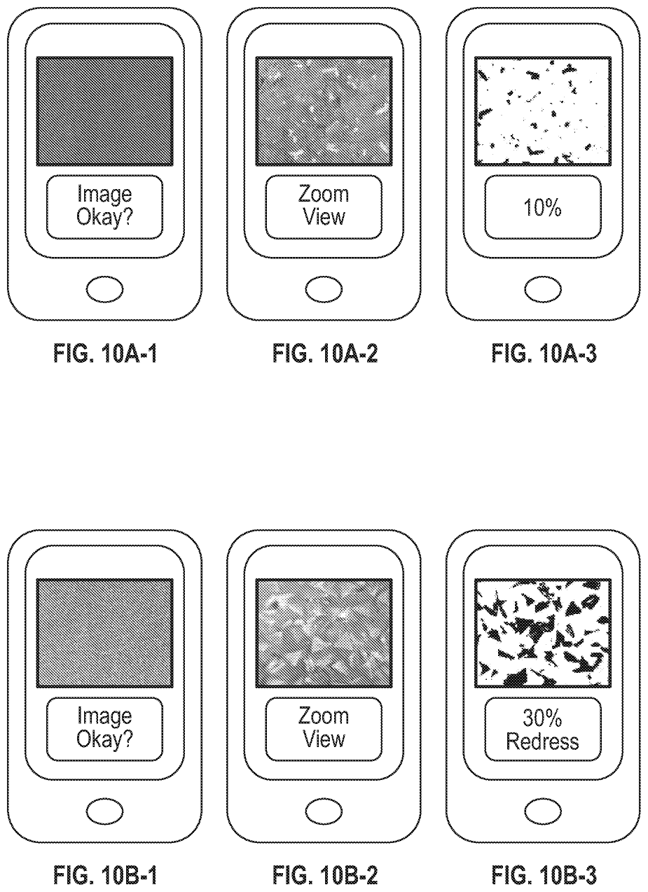

Bearing area fluctuates during an abrasive operation as portions of the disk (including abrasive particles) are exposed, contact a surface, and fracture/are worn away. As the surface changes, the bearing area changes. FIGS. 10A-10B illustrate images that may be collected and/or presented to an operator during an evaluation process. FIGS. 10A-10B illustrate embodiments where a user interacts with the images through a graphical user interface on a smart phone display. However, it is expressly contemplated that the images be viewed on a laptop, desktop, tablet, or other display. Additionally, while images are shown in FIGS. 10A-10B, it is expressly contemplated that textual information could be displayed instead of images. Images may be analyzed and metal capping/bearing area calculations done without any indication to an operator until action is needed to redress or replace the abrasive article.

FIGS. 10A-1, 10A-2 and 10A-3 capture a first point in time for an abrasive article, while FIGS. 10B-1, 10B-2 and 10B-3 capture a second point in time for the same abrasive article. A first image is captured of an abrasive article. It may be possible, as illustrated in the second image, to provide a zoom view for an operator to see individual abrasive particles, such that metal capping or wear is visible. However, such a view is not necessary for the analysis. The third view presents the binary view and an estimate of metal capping or wear currently detected.

FIGS. 10A-10B illustrate a coated abrasive article experiencing wear over time. Wear needs to be measured differently for bonded abrasive articles as, when a first layer of abrasive articles is worn down, new particles are exposed in a lower layer.

Additionally, while FIGS. 10A-10B illustrate a method of determining wear by measuring exposed particle area, it is expressly contemplated that another trigger may indicate end-of-life. For example, precisely shaped grain can be designed to fracture at predictable rates, and fracturing produces a new sharp tip that can effectively abrade a surface. While area of exposed particles is an indication of wear, it does not necessarily correlate completely to end of life. It may be possible to look for other cues through image analysis, such as the make coat, filler particles, or the backing being visible. For example, different color pigments may be present in make resin or pre-size cloth treatments of coated abrasive articles. In bonded abrasive articles, a scrim may become visible or detectable.

The level of wear can be determined by counting the number of pixels which are predicted to be PSG. It can be seen that, as the abrasive is used, more PSG are exposed from underneath a resin coating layer. The surface area of the PSG changes significantly as particle fracturing occurs.

This process of detecting and estimating area of exposed particles can be entirely automated. There are three classes of methods that could be used to solve this problem: traditional machine learning, a convolutional neural network or more traditional rule-based computer vision algorithms. The decision of which algorithm should be used will be based upon the amount of data available for processing and the accuracy required to provide value to the user.

A machine-learning based classifier (for example, either traditional or convolutional neural network) can automatically identify exposed abrasive particles within a captured image. For example, a traditional machine learning algorithm can be trained to, based on FIGS. 10A-2 and 10B-2, extract features from the image to characterize each pixel. One parameter of interest is color as abrasive grain is often differently colored than the resin covering it. Other features, such as shape, structure and texture are also likely to be informative. In the case of a traditional machine learning approach, an SVM or random forest could be trained to make such decisions (other options may also be suitable). When suitably trained on a combination of features, the classifier may be able to quantify wear of particles while capturing the availability of sharp tips remaining.

Images used for evaluating wear can be acquired from a mobile phone, for example assigned to the operator, or any suitable imaging device. Image variability can vary between cameras, however algorithms can be developed to compensate for the variability.

It is likely that, in the handheld context, that lighting conditions will vary as different images are captured. It may be recommended to have abrasive articles imaged in a consistent lighting environment, for example by using the mobile phone in a hood or other controlled environment. In the robotic context, it may be preferred that the abrasive article be imaged in consistent settings—for example with the robot in the same orientation with respect to lighting.

A camera should be calibrated to take accurate images. In situations where a smartphone is used, it may be helpful to have the evaluating algorithm calibrated using a calibration card, with a sample of exposed abrasive on one side, and resin on the other, which may improve accuracy.

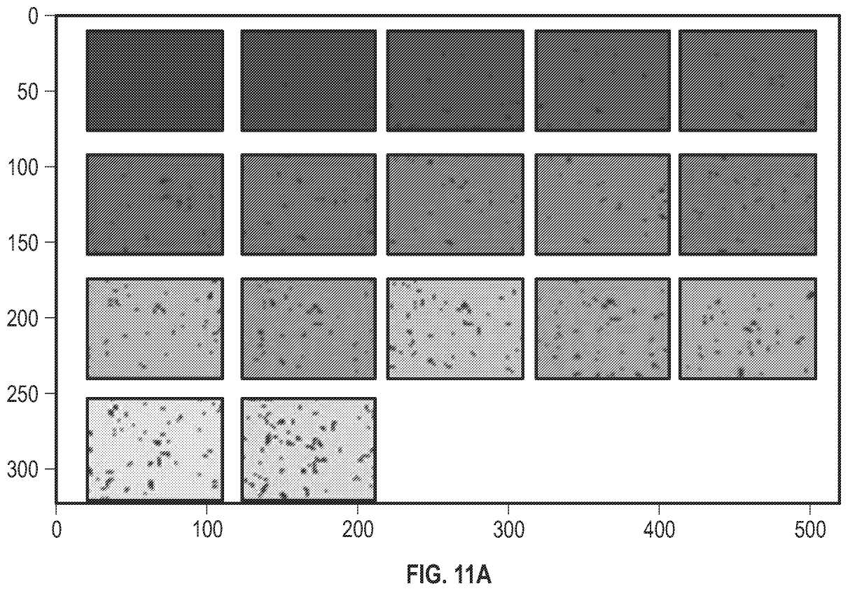

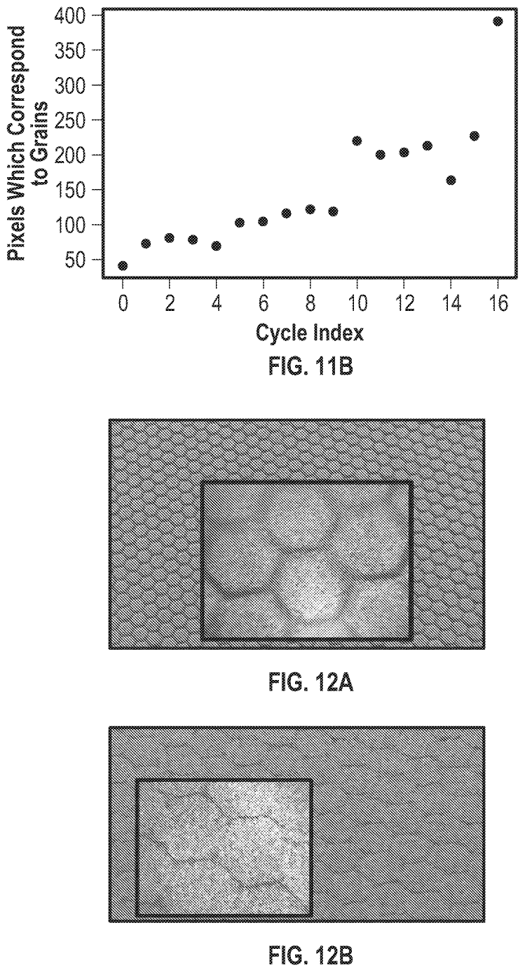

FIGS. 11A-11B illustrate the results of a computer vision algorithm applied to images of an abrasive article over time, showing how the segmentation algorithm can extract the abrasive particles within the photos. As seen, as the cycle index increases, more exposed grains are detectable. FIG. 11B illustrates a plot of exposed abrasive particles in each captured image, showing how more abrasive particles are exposed over time.

For bearing area calculations, it may be beneficial to use structured light to fully capture the 3D aspects of the surface of the abrasive article.

FIGS. 12A-12B illustrate images of an abrasive article surface. The surface is a 363FC sanding belt, with TRIZACT™ abrasive on the surface, unused in FIG. 12A, and 25% used in FIG. 12B. As wear occurs, the microreplicated pattern deteriorates. Computer vision algorithms can be used both to detect deterioration and predict deterioration rates. As illustrated in FIG. 12A, a hexagonal pattern has clear contrast around each raised hexagon structure. In FIG. 12B, after significant use, the contrast is less apparent. Texture analysis may also be done using machine learning to determine abrasive efficiency. Bearing area analysis could also be useful for measuring wear of a micro replicated pattern such as that illustrated in FIGS. 12A-12B.

Using systems and methods described herein, it is possible to image an abrasive article and, based on the image, generate an indication of abrasive efficacy. That abrasive efficacy can be reported in terms of service life remaining, amount of metal capping, available bearing area, number of abrasive operations left (assuming parameters for the next abrasive operations are known), need to redress the abrasive application, or a recommended change in parameters.

If information about a next abrasive operation is known, systems and methods herein can provide an indication of whether the current abrasive article is sufficient for the next operation, or whether a new abrasive article should be used, the existing abrasive article should be redressed, or whether parameters can be changed to increase efficacy. Downstream changes may also be made. For example, a future abrasive operation on the same substrate may need a longer, or shorter, dwell time based on the wear of the abrasive article in the current operation. For example, a more worn abrasive article will leave fewer scratches, and may allow for an intermediate abrading operation to be skipped entirely. However, a worn abrasive article may also not remove as much material as desired, which may require a later step to have a longer dwell time.

If multiple partially used discs are available, systems and methods herein may also be able to suggest which abrasive article is most suitable for a job. For example, if only 5 minutes of abrading is needed, an almost-used-up abrasive disc can be used, reducing waste.

In addition to knowing when to swap out an abrasive article, systems and methods herein may suggest, or automatically change, parameter settings. For example, increasing an applied force from 101b to 151bs at X wear.

Additionally, systems and methods herein may track parameter settings and resulting wear over time to provide better recommendations about service life. For example, it may be found that, at 10 lbs applied force, 10 gates can be ground per disc, but at 15 lbs applied force, 30 gates can be ground before replacement. In the robotic context it may be possible to collect data on abrasive operations, wear, and determine parameter values to increase efficiency for future abrasive operations with the same requirements.

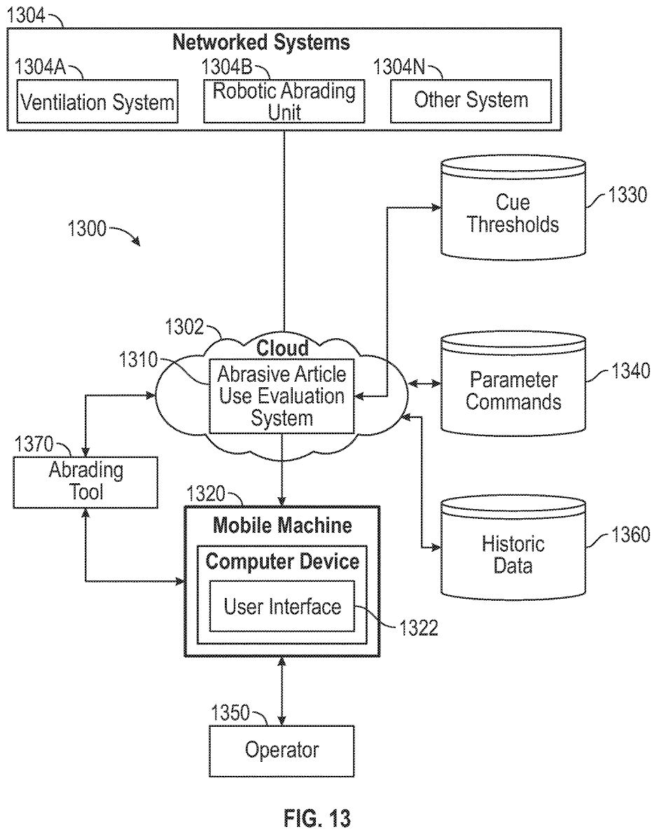

FIG. 13 is a networked architecture for an abrasive article use evaluation system 1310. Architecture 1300 illustrates one embodiment of an implementation of a system 1310, however others are possible. In various embodiments, remote servers can deliver the services over a wide area network, such as the internet, using appropriate protocols. For instance, remote servers can deliver applications over a wide area network and they can be accessed through a web browser or any other computing component.

Software or components, as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

As described herein, based on an indication from abrasive article use evaluation system 1310, a robotic abrading unit 1304B, in response to a command received over a wired or wireless network (e.g. retrieved from commands datastore 1340), may adjust a force or speed or another parameter relevant to an abrasive operation.

Knowing when an abrasive article is nearing an end-of-life may allow for improved environmental health and safety for workers in the immediate environment, in addition to improved efficiency benefits to the abrasive operation. For example, it is known that more dust is produced near the end of life of an abrasive article than at the beginning. Knowing whether an abrasive article(s) in use is near end of life can, for example, be the trigger for a command to be sent to a ventilation system 1304A to increase ventilation in response to the higher dust production. Similarly, a setting for ventilation system 1304A may be reduced when an abrasive article is nearer to the beginning of its useful life. A trigger for changing the ventilation settings may be generated using any of the end-of-life detection methods herein, including detecting visual cues, detecting a change in temperature, detecting physical changes, or by examining swarf.

Similarly, it may be useful to know how used an abrasive article is-not for replacement, but for downstream repairs. Generally, abrasive operations start with the coarsest grade and work down to finer grades to polish a substrate surface. For example, first a 60 grit disc, then an 80 grit disc, before finally a 120 disc. However, if it is known that the 60 grit disc is near its end of life, it may not leave as deep of scratches, and the 80 grit abrading step may be skipped entirely, progressing directly to the 120 grit disc. While such a decision may be made by an experienced operator, similar guidance may be helpful for newer operators, and may increase efficiency of robotic abrading systems.

FIG. 13 specifically shows that a system 1310 can be located at a remote server location 1302. Therefore, computing device 1320 accesses those systems through remote server location 1302. Operator 1350 can use computing device 1320 to access user interfaces 1322 as well. For example, user interface 1322 may provide an indication of how worn an abrasive article is, changes that are made to any of networked systems 1304, or suggested changes to the operation by the operator-such as increasing force, increasing RPMs, etc.

FIG. 13 shows that it is also contemplated that some elements of systems described herein are disposed at remote server location 1302 while others are not. By way of example, storage 1330, 1340 or 1360 or robotic systems 1370 can be disposed at a location separate from location 1302 and accessed through the remote server at location 1302. Regardless of where they are located, they can be accessed directly by computing device 1320, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

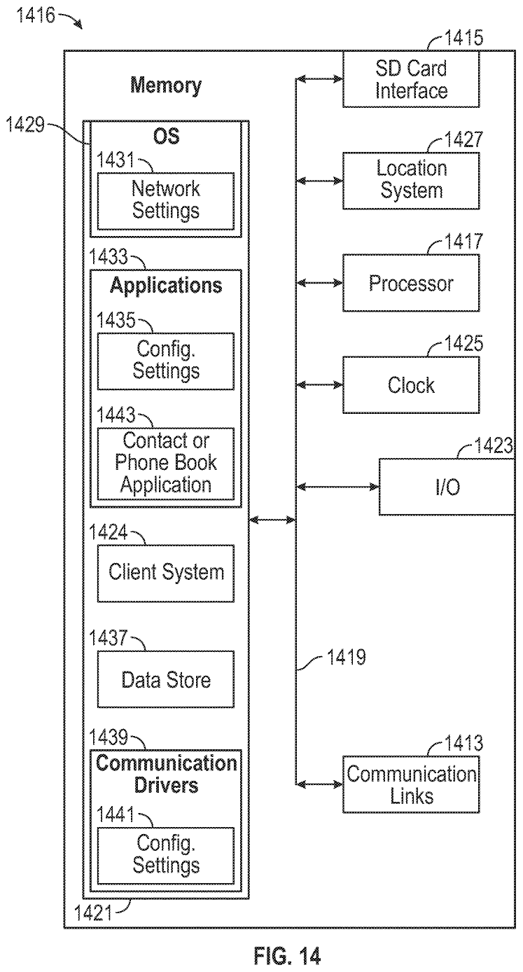

FIGS. 14-16 show examples of computing devices that can be used in embodiments shown in previous Figures.

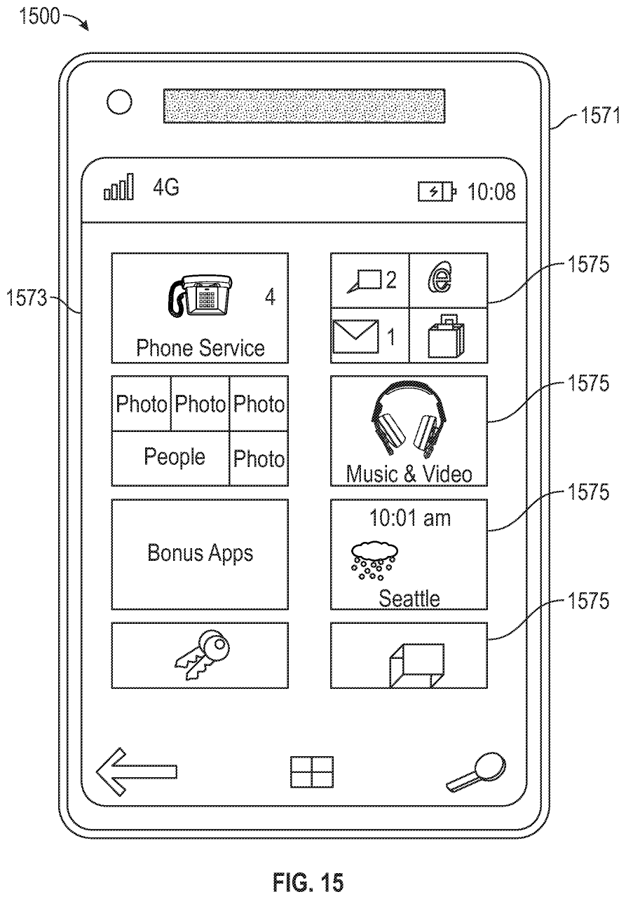

FIG. 14 is a simplified block diagram of one illustrative example of a handheld or mobile computing device that can be used as a user's or client's handheld device 1416 (e.g., as computing device 1320 in FIG. 13), in which the present system (or parts of it) can be deployed. For instance, a mobile device can be deployed in the operator compartment of computing device 1320 for use in generating, processing, or displaying the data. FIG. 15 is another example of a handheld or mobile device.

FIG. 14 provides a general block diagram of the components of a client device 1416 that can run some components shown and described herein. Client device 1416 interacts with them, or runs some and interacts with some. In the device 1416, a communications link 1413 is provided that allows the handheld device to communicate with other computing devices and under some embodiments provides a channel for receiving information automatically, such as by scanning. Examples of communications link 1413 include allowing communication though one or more communication protocols, such as wireless services used to provide cellular access to a network, as well as protocols that provide local wireless connections to networks.

In other examples, applications can be received on a suitable removable memory card (such as an Secure Digital (SD) card, CF card, microSD or portable hard drive) that is connected to an interface 1415. Interface 1415 and communication links 1413 communicate with a processor 1417 (which can also embody a processor) along a bus 1419 that is also connected to memory 1421 and input/output (I/O) components 1423, as well as clock 1425 and location system 1427.

I/O components 1423, in one embodiment, are provided to facilitate input and output operations and the device 1416 can include input components such as buttons, touch sensors, optical sensors, microphones, touch screens, proximity sensors, accelerometers, orientation sensors and output components such as a display device, a speaker, and or a printer port. Other I/O components 1423 can be used as well.

Clock 1425 illustratively comprises a real time clock component that outputs a time and date. It can also provide timing functions for processor 1417.

Illustratively, location system 1427 includes a component that outputs a current geographical location of device 1416. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1421 stores operating system 1429, network settings 1431, applications 1433, application configuration settings 1435, data store 1437, communication drivers 1439, and communication configuration settings 1441. Memory 1421 can include all types of tangible volatile and non-volatile computer-readable memory devices. It can also include computer storage media (described below). Memory 1421 stores computer readable instructions that, when executed by processor 1417, cause the processor to perform computer-implemented steps or functions according to the instructions. Processor 1017 can be activated by other components to facilitate their functionality as well.

FIG. 15 shows that the device can be a smart phone 1500. Smart phone 1571 has a touch sensitive display 1573 that displays icons or tiles or other user input mechanisms 1575. Mechanisms 1575 can be used by a user to run applications, make calls, perform data transfer operations, etc. In general, smart phone 1571 is built on a mobile operating system and offers more advanced computing capability and connectivity than a feature phone.

Note that other forms of the devices 1400, 1500 are possible.

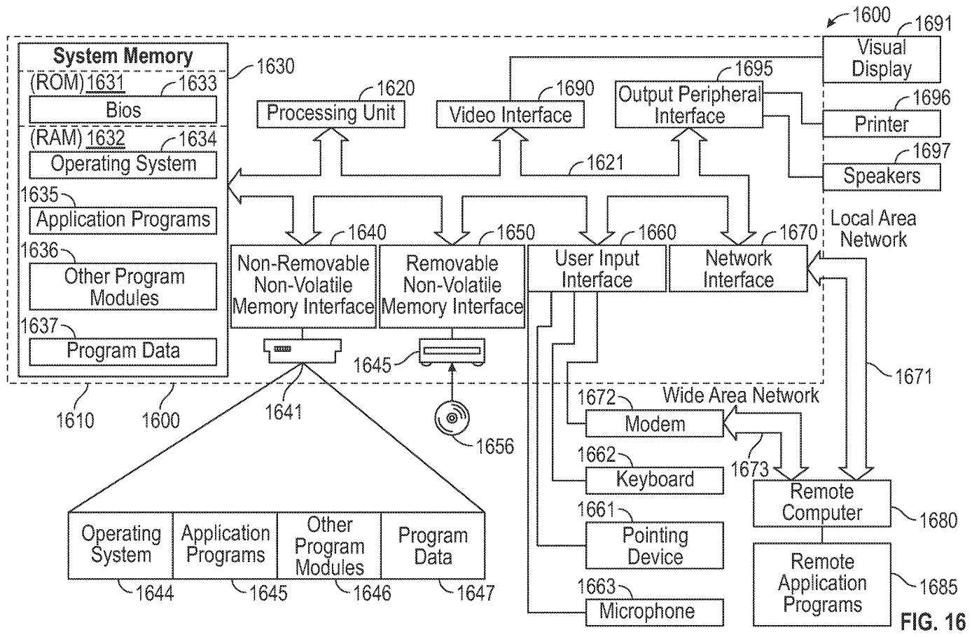

FIG. 16 is a block diagram of a computing environment that can be used in embodiments shown in previous Figures.

FIG. 16 is one example of a computing environment in which elements of systems and methods described herein, or parts of them (for example), can be deployed. With reference to FIG. 16, an example system for implementing some embodiments includes a general-purpose computing device in the form of a computer 1610. Components of computer 1610 may include, but are not limited to, a processing unit 1620 (which can comprise a processor), a system memory 1630, and a system bus 1621 that couples various system components including the system memory to the processing unit 1620. The system bus 1621 may be any of several types of bus structures including a memory bus or memory controller, a peripheral bus, and a local bus using any of a variety of bus architectures. Memory and programs described with respect to systems and methods described herein can be deployed in corresponding portions of FIG. 16.

Computer 1610 typically includes a variety of computer readable media. Computer readable media can be any available media that can be accessed by computer 1610 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1610. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1630 includes computer storage media in the form of volatile and/or nonvolatile memory such as read only memory (ROM) 1631 and random access memory (RAM) 1632. A basic input/output system 1633 (BIOS) containing the basic routines that help to transfer information between elements within computer 1610, such as during start-up, is typically stored in ROM 1631. RAM 1632 typically contains data and/or program modules that are immediately accessible to and/or presently being operated on by processing unit 1620. By way of example, and not limitation, FIG. 16 illustrates operating system 1634, application programs 1635, other program modules 1636, and program data 1637.

The computer 1610 may also include other removable/non-removable and volatile/nonvolatile computer storage media. By way of example only, FIG. 16 illustrates a hard disk drive 1641 that reads from or writes to non-removable, nonvolatile magnetic media, nonvolatile magnetic disk 1652, an optical disk drive 1655, and nonvolatile optical disk 1656. The hard disk drive 1641 is typically connected to the system bus 1621 through a non-removable memory interface such as interface 1640, and optical disk drive 1655 are typically connected to the system bus 1621 by a removable memory interface, such as interface 1650.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 16, provide storage of computer readable instructions, data structures, program modules and other data for the computer 1610. In FIG. 16, for example, hard disk drive 1641 is illustrated as storing operating system 1644, application programs 1645, other program modules 1646, and program data 1647. Note that these components can either be the same as or different from operating system 1634, application programs 1635, other program modules 1636, and program data 1637.

A user may enter commands and information into the computer 1610 through input devices such as a keyboard 1662, a microphone 1663, and a pointing device 1661, such as a mouse, trackball or touch pad. Other input devices (not shown) may include a joystick, game pad, satellite receiver, scanner, or the like. These and other input devices are often connected to the processing unit 1620 through a user input interface 1660 that is coupled to the system bus, but may be connected by other interface and bus structures. A visual display 1691 or other type of display device is also connected to the system bus 1621 via an interface, such as a video interface 1690. In addition to the monitor, computers may also include other peripheral output devices such as speakers 1697 and printer 1696, which may be connected through an output peripheral interface 1695.

The computer 1610 is operated in a networked environment using logical connections, such as a Local Area Network (LAN) or Wide Area Network (WAN) to one or more remote computers, such as a remote computer 1680.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. In a networked environment, program modules may be stored in a remote memory storage device. FIG. 16 illustrates, for example, that remote application programs 1685 can reside on remote computer 1680.

Objects and advantages of this disclosure are further illustrated by the following non-limiting examples, but the particular materials and amounts thereof recited in these examples, as well as other conditions and details, should not be construed to unduly limit this disclosure.

An abrasive article evaluation system is presented that includes a camera that images an abrasive article. The system includes an efficiency indication generator that, based on the image, generates an indication of abrasive efficacy for the abrasive article. The system also includes a command generator that generates a command based in the generated abrasive efficacy indication.

The system may be implemented such that it also includes a parameter retriever that retrieves a current operational parameter for a tool associated with the abrasive article. The command generator generates a command to adjust the operational parameter from a first value to a second value, different from the first value.

The system may be implemented such that the operational parameter is an applied force, the tool is a robotic abrading unit and the second value is a higher applied force than a first applied force.

The system may be implemented such that the operation parameter is a speed, and a second speed is higher than a first speed.

The system may be implemented such that the operation parameter is an abrading angle, and a second abrading angle is different than a first abrading angle.

The system may be implemented such that the command is a replacement command and a robotic abrading unit associated with the abrasive article initiates an abrasive article replacement sequence automatically, based on the command.

The system may be implemented such that the command is a redress command and a robotic abrading unit moves the abrasive article to a redressing station, based on the command.

The system may be implemented such that the command is a downstream operation command that, based on the indication of wear, adjusts a downstream abrading operation parameter.

The system may be implemented such that the downstream abrading operation parameter is a speed, a force or a dwell time.

The system may be implemented such that the downstream abrading operation parameter is a second abrasive operation with a second abrasive article.

The system may be implemented such that it includes a historic value retriever that retrieves a historic value for the operational parameter.

The system may be implemented such that the camera captures the image in response to an efficacy evaluation initiator, which generates a trigger to actuate the camera.

The system may be implemented such that the efficacy evaluation initiator generates the trigger periodically.

The system may be implemented such that the efficacy evaluation initiator generates the trigger in response to a manual input.

The system may be implemented such that the efficacy evaluation initiator generates the trigger before an abrading operation starts.

The system may be implemented such that the efficacy evaluation initiator generates the trigger at an end of an abrading operation.

The system may be implemented such that the command is a graphical user interface update command, and the command is communicated to a device with a display, and the command causes the display to present an updated graphical user interface.

The system may be implemented such that it includes a command communicator that communicates the command to a second device.

The system may be implemented such that the second device is a robotic abrading unit.

The system may be implemented such that the second device is a ventilation system.

The system may be implemented such that the second device is a dust collection system.

The system may be implemented such that the abrasive efficacy indication is a metal capping measurement.

The system may be implemented such that the abrasive efficacy indication is a wear estimation.

The system may be implemented such that the abrasive efficacy indication is a remaining service life estimation.

The system may be implemented such that the camera is integrated into a portable computing device.

The system may be implemented such that the camera is mounted on a robotic abrading system.

The system may be implemented such that it includes a structured light source.

The system may be implemented such that it includes a mount that maintains a position of the camera.

A robotic abrading system is presented that includes an abrasive article including abrasive particles within a bond matrix. The system also includes a robot arm configured to move one of the abrasive article and a substrate into position, such that the abrasive article contacts the substrate. The system also includes a force control unit on the robot arm. The force control unit applies a force to the abrasive article or the substrate. The system also includes an article evaluation system that images the abrasive article, evaluates the abrasive article, and, based on the evaluation, generates an updated operational parameter for the robotic abrading system.

The robotic abrading system may be implemented such that the article evaluation system includes a wear estimator that estimates an amount of wear of the abrasive article.

The robotic abrading system may be implemented such that the article evaluation system includes a metal capping detector that detects an amount of metal capping on the abrasive article.

The robotic abrading system may be implemented such that the metal capping detector segments a captured image.

The robotic abrading system may be implemented such that the metal capping detector converts a captured image to binary.

The robotic abrading system may be implemented such that the metal capping detector quantifies an area of the abrasive article that is reflective.

The robotic abrading system may be implemented such that the article evaluation system includes an ultrasonic calipers.

The robotic abrading system may be implemented such that the updated operational parameter is to redress the abrasive article before a next operation.

The robotic abrading system may be implemented such that the abrasive article evaluation system includes a camera that images the abrasive article.

The robotic abrading system may be implemented such that it includes a structured light source.

The robotic abrading system may be implemented such that the camera is mounted to the robotic arm.

The robotic abrading system may be implemented such that the camera is separate from the robotic arm.

The robotic abrading system may be implemented such that the camera, the substrate, or the abrasive article is coupled to a movement mechanism.

The robotic abrading system may be implemented such that the camera images a surface of the abrasive article.

The robotic abrading system may be implemented such that the camera images a profile of the abrasive article.

The robotic abrading system may be implemented such that the operational parameter is an abrasive article replacement.

The robotic abrading system of may be implemented such that the operational parameter is an applied force by the force control unit, a rotational speed of the abrasive article, or a dwell time of the abrasive article on the substrate.

The robotic abrading system may be implemented such that the operational parameter is a parameter for a future abrasive operation on the substrate.

The robotic abrading system may be implemented such that the operational parameter is a parameter for a future abrasive operation using the abrasive article.

The robotic abrading system may be implemented such that the article evaluation system actuates in response to an initiation command from a controller.

The robotic abrading system may be implemented such that the controller sends the initiation command periodically.

The robotic abrading system may be implemented such that the controller sends the initiation command at a start of, or at an end of, an abrading operation.

The robotic abrading system may be implemented such that the controller generates the command to adjust the operation parameter.

The robotic abrading system may be implemented such that the article evaluation system compares a metal capping amount to a metal capping threshold and, if the metal capping amount exceeds the metal capping threshold, a redress command or a replacement command is generated for the abrasive article.

The robotic abrasive system may be implemented such that the metal capping threshold is based on operational parameters of the abrasive operation.

The robotic abrasive system may be implemented such that the metal capping threshold is based on operational parameters of a future abrasive operation.

The robotic abrading system may be implemented such that the article evaluation system compares a wear amount to a wear threshold and, if the wear amount exceeds the wear threshold, a replace command is generated for the abrasive article.

The robotic abrading system may be implemented such that the wear threshold is based on operational parameters of a future abrasive operation.

The robotic abrading system may be implemented such that the abrasive article includes a backing and the bond matrix includes a make coat layer that binds the abrasive particles to the backing.

The robotic abrading system may be implemented such that the abrasive article includes an abrasive disc or an abrasive belt.

The robotic abrading system may be implemented such that the abrasive article is a bonded abrasive article, and the bond matrix is a vitreous, resin, polymer or metal bond matrix.

The robotic abrading system may be implemented such that the abrasive article is a nonwoven abrasive article including a plurality of nonwoven fibers, and the bond matrix binds the abrasive particles to the plurality of nonwoven fibers.

A system for evaluating abrasive article efficacy includes a tool coupled to an abrasive article, the abrasive article having abrasive particles on an abrading surface. The system also includes a surface profiler configured to capture an indication of the abrading surface. The system also includes an evaluator that: receives the captured indication, processes the captured indication, and generates an abrading efficacy indication.

The system may be implemented such that the surface profiler includes a camera, and the captured indication is an image.

The system may be implemented such that the surface profiler is a 3D profilometer and the captured indication is a surface profile indication.

The system may be implemented such that it includes a structured light source.

The system may be implemented such that the evaluator also communicates the abrading efficacy indication to a receiving device.

The system may be implemented such that the receiving device is a display component, and communicating the abrading efficacy indication includes communicating an update for a graphical user interface of the display component.

The system may be implemented such that the receiving device is a robotic abrading system coupled to the tool, and the system also includes an abrasive parameter updater that, based on the abrading efficacy indication, generates a set of updated parameters for the robotic abrading system. The updated parameters change one of an applied force, a rotational speed or a dwell time.

The system may be implemented such that the abrading efficacy indication includes a wear indication.

The system may be implemented such that the abrading efficacy indication includes a metal capping indication.

The system may be implemented such that the abrading efficacy indication includes an estimated service life remaining.

The system may be implemented such that the estimated service life remaining includes a number of future abrasive operations remaining.

The system may be implemented such that the display component is associated with the tool.

The system may be implemented such that the display component is in an area of a worksite near the tool.

The system may be implemented such that the display component is part of a device associated with the operator of the tool.

The system may be implemented such that the device is a personal protective equipment worn by the operator.

The system may be implemented such that the abrasive article includes an abrasive disc or an abrasive belt.

The system may be implemented such that the abrasive article is a bonded abrasive article.

The system may be implemented such that the abrasive article is a nonwoven abrasive article.

A method of abrading a substrate is presented that includes contacting a substrate surface with an abrasive article, the abrasive article having a surface, capturing a surface indication of the surface, using a surface indication capturing device, and processing the surface indication, using an abrasive efficiency evaluator, to generate an abrasive efficacy indication. Based on the abrasive efficacy indication, modifying a next abrasive operation for the abrasive article.

The method may be implemented such that modifying includes adding a redressing step for the abrasive article before the next abrasive operation.

The method may be implemented such that modifying includes adjusting an applied force, a speed or a dwell time.

The method may be implemented such that modifying includes exchanging the abrasive article for a new abrasive article before the next abrasive operation.

The method may be implemented such that the abrasive article is coupled to a robotic abrading system. Modifying includes: generating a command, based on the abrasive efficacy education, and communicating the command to the robotic abrading system.

The method may be implemented such that the abrasive article is coupled to a handheld power tool. Modifying includes providing the abrasive efficacy indication to a display associated with the handheld power tool or associated with an operator of the handheld power tool.

The method may be implemented such that the abrasive article is coupled to a handheld power tool and modifying includes providing a modification instruction to an operator.

The method may be implemented such that the modification instruction is provided using a personal protective device worn by the operator.

The method may be implemented such that the modification instruction is provided through a speaker of a hearing protection unit.

The method may be implemented such that the modification instruction is provided on a heads up display.

The method may be implemented such that the modification instruction is provided to a portable computing device associated with the operator.

The method may be implemented such that it includes communicating the abrasive efficacy indication to a datastore.

The method may be implemented such that the abrasive efficacy indication is communicated with an indication of a set of current operating parameters for the abrasive article.

The method may be implemented such that the abrasive efficacy indication includes a wear indication or a metal capping indication.

The method may be implemented such that the surface indication is an image of the surface.

The method may be implemented such that processing the image includes segmenting the image.

The method may be implemented such that processing the image includes converting the image to binary.

The method may be implemented such that processing the image includes applying machine learning to detect exposed abrasive particles or capped abrasive particles.

The method may be implemented such that processing the image includes measuring reflectance from the abrasive article.

The method may be implemented such that the surface indication includes a surface profile indication.

The method may be implemented such that the surface indication capturing device includes a structured light microscope.

The method may be implemented such that the surface indication capturing device includes a 3D profilometer.

### EXAMPLES

### EXAMPLE 1

An algorithm has been written to analyze the disc and identify PSG grains. The algorithm uses information which is provided by the angle of the lighting/shadows and observing the coverage of the red layer of the abrasive. The computer vision algorithm picks out specific colors of the grains in images to demonstrate how the segmentation algorithm extracts PSG within the photos. It can be seen that the blue color of the PSG is more exposed as the images progress, indicating a strong correlation to abrasive wear.

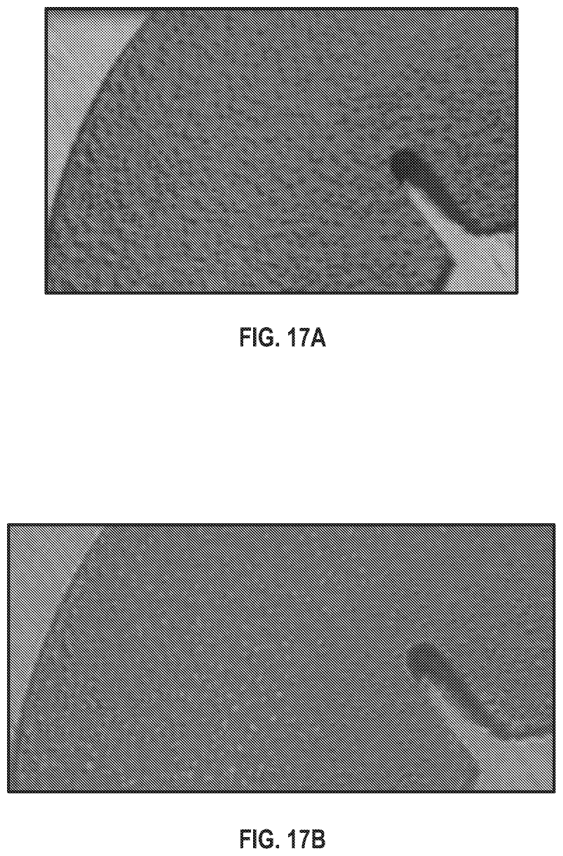

PSG grains are then assessed for their wear. In the images of FIGS. 17A-17B, regions that have been worn are colored in a first color and those which have not been worn are represented as a second color. Some PSG grains are part first color and part second color which indicates that it has been partially worn.

The wear status of the disc can then be calculated using statistics;
1) G=Number of first color pixels (worn PSD); P=Number of second color pixels (not worn PSG). W=% of disc wear;
W=G/(G+P)
   W could be displayed to the user as a color scale to indicate % of disc wear
2) Regional assessments of disc wear could be computed in a similar way to above. These regions could be in concentric circles. This may add value because visually it appears the greatest wear occurs in the central ring on the disc. The % wear maybe experienced by the user to a greater extent in this region. A weighting could be learned which would represent the users experience when reporting the % wear statistic to the user.
3) The value of W could be correlated with time remaining of disc usage. This would be achieved by asking operators to use an abrasive disc for varying time periods and observing W. Regression would be used initially to predict time remaining. If a poor R\hat{ }2 value/p value was achieved, further parameters could be integrated for more sophisticated investigations such as multi-linear or non-linear regression.
4) These scores could be further personalized to an individual operator using machine learning. For the purpose of a concise IS, the details of this are not covered here but can be upon request. This would be a feature which would be implemented on horizon 2 or 3 on a road map of features.

### Technical Methodology

From a technical perspective, this was achieved through training a machine learning classifier (specifically random forest) to predict the status of each pixel in the image based on its numerical value and the numerical value of its neighboring pixels. Features computations are used to achieve this and the features computed include first and second differential of the regions, with a Gaussian pyramid.

There are other ways to achieve this but it serves as an example;

FIG. 17A is a new disc. FIG. 17B is an output image which is annotated based on whether a grain has been used. Green means it has been used, purple means it has not been used.

All Red pixels in the right image predict are predicted to not be abrasive grains and excluded from the calculation.

### EXAMPLE 2

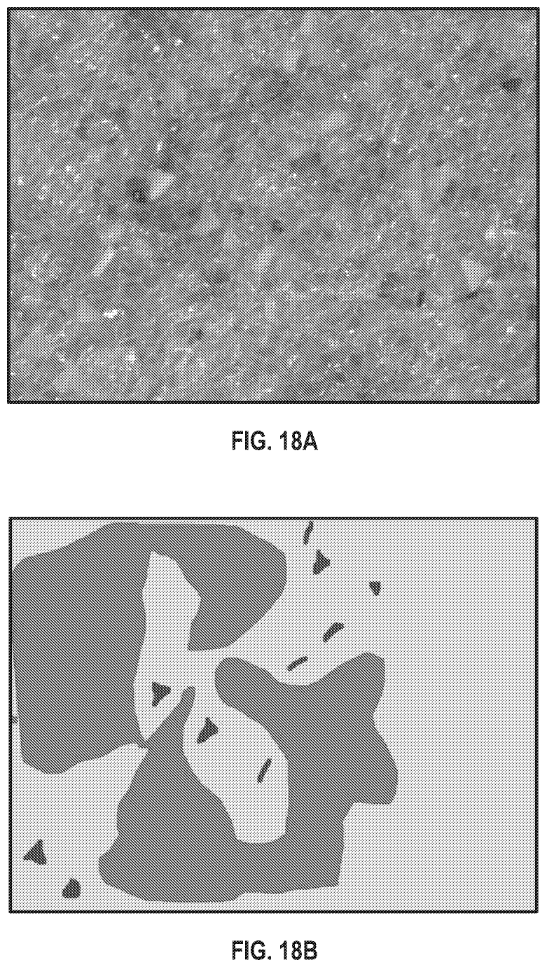

Previously, a machine learning algorithm has been created to help manufacturing to diagnose manufacturing challenges with optical microscopy. FIG. 18A illustrates a microscopy image acquired of an abrasive article.

Input training data for the machine learning algorithm by a human, as illustrated in FIG. 18B. The corresponding colors in the below image were:
red: manually labelled as background regions
blue: manually labelled PSG
green: unlabelled region that the machine learning algorithm predicts its class.

### EXAMPLE 3

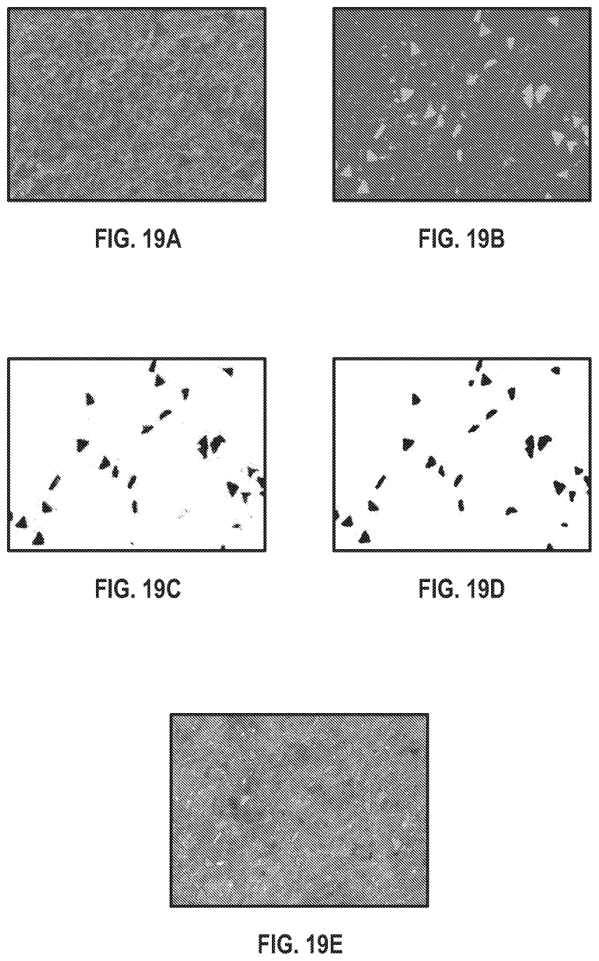

A random forest was created to predict the class of the green region as PSG or “background”. A series of intermediate images are generated to assist the classifier, for example as illustrated in FIGS. 19A and 19B.

A probability map, shown in FIG. 19C, depicts the regions likely to be PSG. The thresholded image, shown in FIG. 19D) provides a binary image representing where the PSG can be located.

The results can be superimposed on the original image to pick out the PSG (outlined in FIG. 19E).

### EXAMPLE 4

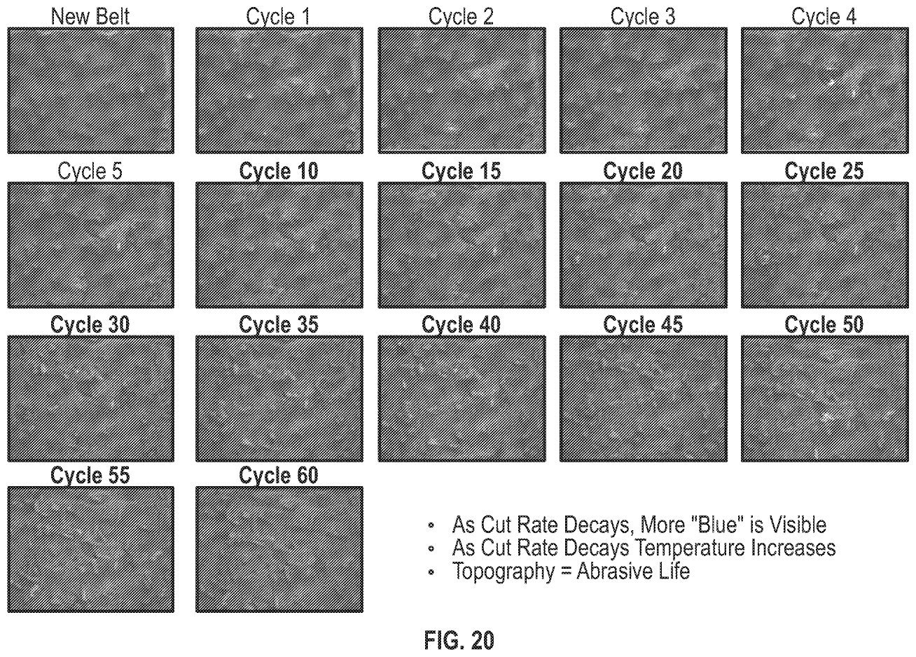

FIG. 20 shows multiple imagines of the same abrasive surface when subjected to fixed grinding conditions. Which each grinding cycle there is an increase in visible abrasive grain which is linked to the fracturing mechanism of the ceramic mineral. The abrasive grain, in this case a ‘Precision shaped grain’ will grind less material as it wears, and in tandem will incur higher temperature grinding. The PSG grains are blue and therefore are easy to pick out Vs the red background of the abrasive. The area of visible blue grain can be utilized to calculate an area of abrasive Vs the red background, giving a powerful indication of abrasive life.

1. An abrasive article evaluation system comprising:
a camera that images an abrasive article;
an efficiency indication generator that, based on the image, generates an indication of abrasive efficacy for the abrasive article; and
a command generator that generates a command based in the generated abrasive efficacy indication, wherein the command is a downstream operation command that, based on the indication of wear, adjusts a downstream abrading operation parameter.

2. The system of claim 1, further comprising:
a parameter retriever that retrieves a current operational parameter for a tool associated with the abrasive article; and
wherein the command generator generates a command to adjust the operational parameter from a first value to a second value, different from the first value.

3. The system of claim 2, wherein the operational parameter is an applied force, the tool is a robotic abrading unit and the second value is a higher applied force than a first applied force.

4. The system of claim 2, wherein the operation parameter is a speed, and wherein a second speed is higher than a first speed.

5. The system of claim 2, wherein the operation parameter is an abrading angle, and wherein a second abrading angle is different than a first abrading angle.

6. The system of claim 1, wherein the command is a redress command and wherein a robotic abrading unit moves the abrasive article to a redressing station, based on the command.

7. (canceled) The system of claim 1, wherein the command is a downstream operation command that, based on the indication of wear, adjusts a downstream abrading operation parameter.

8. The system of claim 1, wherein the camera captures the image in response to an efficacy evaluation initiator, which generates a trigger to actuate the camera.

9. The system of claim 1, wherein the command is a graphical user interface update command, and wherein the command is communicated to a device with a display, and wherein the command causes the display to present an updated graphical user interface.

10. The system of claim 1, further comprising:
a command communicator that communicates the command to a second device.

11. The system of claim 1, and wherein the abrasive efficacy indication is a metal capping measurement.

12. The system of claim 1, wherein the abrasive efficacy indication is a wear estimation.

13. The system of claim 1, wherein the abrasive efficacy indication is a remaining service life estimation.

14. The system of claim 1 further comprising a structured light source.

15. The system of claim 1 further comprising a mount that maintains a position of the camera.

16. A robotic abrading system comprising:
an abrasive article comprising abrasive particles within a bond matrix;
a robot arm configured to move one of the abrasive article into position and a substrate such that the abrasive article contacts the substrate;
a force control unit on the robot arm wherein the force control unit applies a force to the abrasive article or the substrate; and
an article evaluation system that:
images the abrasive article;
evaluates the abrasive article, and,
based on the evaluation, generates an updated operational parameter for the robotic abrading system.

17. The robotic abrading system of claim 16, wherein the article evaluation system comprises:
a wear estimator that estimates an amount of wear of the abrasive article.

18. The robotic abrading system of claim 16, wherein the article evaluation system comprises:
a metal capping detector that detects an amount of metal capping on the abrasive article.

19. The robotic abrading system of claim 18, wherein the metal capping detector segments a captured image.

20. The robotic abrading system of claim 16, wherein the article evaluation system comprises an ultrasonic calipers.

21. The robotic abrading system of claim 16, wherein the abrasive article evaluation system comprises a camera that images the abrasive article.

22. The robotic abrading system of claim 21, further comprising a structured light source.

23. The robotic system of claim 16, wherein the camera, the substrate, or the abrasive article is coupled to a movement mechanism.

24. The robotic system of claim 16, wherein the operational parameter is an applied force by the force control unit, a rotational speed of the abrasive article, or a dwell time of the abrasive article on the substrate.

25. The robotic system of claim 16, wherein the operational parameter is a parameter for a future abrasive operation on the substrate.

26. The robotic system of claim 16, wherein the operational parameter is a parameter for a future abrasive operation using the abrasive article.

27. The robotic system of claim 16, wherein the article evaluation system compares a metal capping amount to a metal capping threshold and, if the metal capping amount exceeds the metal capping threshold, a redress command or a replacement command is generated for the abrasive article.

28. The robotic system of claim 16, wherein the article evaluation system compares a wear amount to a wear threshold and, if the wear amount exceeds the wear threshold, a replace command is generated for the abrasive article.

29. The robotic system of claim 28, wherein the wear threshold is based on operational parameters of a future abrasive operation.

30.-40. (canceled)
